(19) United States
(12) Patent Application Publication
(10) Pub. No.: US 2026/0261745 A1
(43) Pub. Date: Sep. 3, 2026

(54) System and Method for Optimizing Digital Assets

(71) Applicant: Eikona Technologies Inc., Tel Aviv (IL)

(72) Inventors: Omer HACOHEN, Kibutz Tzora (IL); Nir WEINGARTEN, Tel-Aviv (IL)

(21) Appl. No.: 19/543,034

(22) Filed: Feb. 18, 2026

Related U.S. Application Data
(60) Provisional application No. 63/759,849, filed on Feb. 18, 2025.

(51) Int. Cl. H04N 21/854; H04N 21/466

(52) U.S. Cl. CPC H04N 21/854; H04N 21/4667

(57) ABSTRACT

A computerized method for iterative generation and optimization of media assets is disclosed. A pre-trained generative model encodes a media asset into a latent space vector within a smooth or semi-smooth latent space, wherein controlled variations of the vector correspond to controlled semantic or visual variations of the media asset. Multiple controlled latent variations are generated at a bounded distance from the vector and decoded to produce corresponding media assets. The generated media assets are presented to users in an A/B test, and performance is measured according to a selected key performance indicator (KPI). A media asset having superior KPI performance is selected and iteratively reused for further latent variation and evaluation until a termination criterion is satisfied, at which point the selected media asset is output.

### FIELD OF THE INVENTION

The present invention is in the general field of Generative AI (GenAI) for use in various applications.

### BACKGROUND

In many real-world applications, it is beneficial to find a media asset which is optimal for some downstream task quantifiable by some KPI. For example, one can consider a site that distributes information about the dangers of prolonged sun exposure and the available proactive actions that can be taken. In such a setting, it is very important that the user will read as much of the information as possible. In this example one can choose the scrolling depth as the KPI and the background image of the site as the media—hence the task is to find the optimal background image to maximize the scrolling depth of the user.

Another possible example can be a university that is struggling with account takeovers, and wants to boost two-factor authentication (2FA) adoption. The university's IT department sends an email to drive the students to enable 2FA. The KPI here can be defined as the rate of 2FA enablement, and the media is the content of the email. The task at hand would be to find the optimal email content (text for this example) to maximize the rate of 2FA enablement.

Experience shows (e.g., Digital Experimentation and Startup Performance: Evidence from A/B Testing, Harvard business school) that such “optimal” media assets can have a significant impact on user behavior, up to factors of hundreds of percent and more.

Such media assets may include, but are not limited to, images, text copy, videos, audio samples, visual layout of other assets, etc. Finding an optimal asset is often very difficult, since a direct theoretical mapping from the media-space to the KPI-space does not exist, resulting in a black-box optimization problem.

Current content optimization methods rely on qualitative user studies and manual, human-guided A/B testing, which is often biased. The selection of media assets for these tests involves a human-in-the-loop process, analyzing past results to identify perceived winning traits. An example for this process can be a conclusion drawn by an analyst to attribute success to simple factors such as an image having a “red background”, or a sentence being “too long”. However, the true reasons behind an asset's performance might indeed be far more complex, nuanced, and intertwined, suggesting that the existing approaches are overly simplistic, and potentially misleading. Such a manual process is inclined to produce new media assets that are only loosely linked to the results of the performed tests.

These assets can be “authentic (i.e. created in a photoshoot in the case of images or by a creative human process in the case of copy text) or AI-generated, but the generative process is only loosely linked (by a manual, human guiding process) to previous tests results.

A generative machine-learning model can generate novel media assets and condition the generation with arbitrary conditional information provided as input. Such conditions can include, but are not limited to: text (prompt), depth maps/pose maps¹, other media assets². Note that these prior arts condition the generative process by applying a condition in the form of a media asset, that is, the condition itself is in the media space.

Prior art has tackled the task of automating the A/B testing process by linking the media asset generation process to the results from A/B test iterations. An example for such a content optimizing system is shown in U.S. Pat. No. 9,741,043, where a rule based text generation model is used followed by A/B testing. Such a rule based approach is confined to short text only, and does not explore the full space of language due to the limiting nature of rule-based models.

Optimizing media using manual A/B tests with “authentic” assets or with “AI-generated” ones using the above conditioning methods poses several key problems:
1) The differences between assets are not “controllable,” making it challenging to regulate the degree of semantic or visual change. In generative models, even slight variations in prompts can lead to significant shifts in the generated media. While alternative conditioning methods (as mentioned earlier) mitigate some of these issues, they do not provide a complete solution. This is because the user of such methods must be very explicit about the required change in media space, meaning he has to know in advance what would work. Another problem with these conditioning mechanisms is that they do not allow complex changes in the media (where multiple aspects are changing simultaneously). This “uncontrollability” complicates the optimization process, as it cannot be reliably forecast how one media asset will perform (what KPI will be induced by it) based on the performance of another asset for which the KPI was measured.
2) Choosing how to change the media to increase the “KPI” is unclear. We can try to use past A/B tests experience to distill actionable insights as to what “works”—but in practice doing so is very hard and resorts to first order approximations of the reasons as to what works (such as “this worked because the background color was red”) when usually the reason a certain media asset “works” is very complex (i.e. has interconnected components). On the same note, this analysis is done by a human which is usually biased in a lot of ways to choose certain change “directions”.
3) Using “authentic” assets or “ai-generated” ones with current conditioning mechanisms for generative models “discritisizes” the search space, as there exists an infinite amount of images between the images generated by different prompts, which can not be easily achieved (or not achieved at all) by changing the prompt (See FIGS. 1A-D). Some conditioning mechanism (such as inpainting) alleviates parts of this problem by conditioning on the original media asset and keeping parts of it constant. But they confine the search to assets with the part kept constant.

The current invention proposes a novel method to automate media asset optimization, utilizing conditioned media asset generation.

### SUMMARY OF THE INVENTION

According to one aspect of the presently disclosed subject matter there is provided a computerized method for iterative media asset generation and optimization, comprising:
(i) providing a pre-trained generative model and a media asset in a media space;
(ii) encoding, by the generative model, the media asset into a latent space vector within a smooth or semi-smooth latent space such that controlled variations in the latent vector correspond to controlled semantic or visual variations in a corresponding media asset;
(iii) creating, in the latent space, at least two controlled latent variations of the latent vector, each variation being a latent space vector at a maximal controlled distance epsilon from the latent vector and generated along an exploration direction;
(iv) generating, using the generative model, at least two media assets corresponding to the controlled variations, the generated assets exhibiting controlled asset variations relative to the media asset or a previously selected media asset;
(v) conducting an A/B test by presenting the generated media assets to users and measuring KPI performance associated with a KPI type;
(vi) selecting the generated media asset having the best measured KPI performance; when the measured KPI of the selected media asset fails to satisfy an exit criterion,
(vii) repeating stages (ii)-(vi) using the selected media asset as the media asset for the next iteration; and
(viii) outputting the selected media asset when the exit criterion is satisfied.

In addition to the above features, the method according to this aspect of the presently disclosed subject matter can comprise one or more of features (1) to (9) listed below, in any desired combination or permutation which is technically possible:
(1) wherein the exit criterion is selected from the group that includes:
   a) the measured KPI associated with the selected media asset of the current iteration does not achieve improvement over the measured KPI associated with the selected media asset of a previous iteration;
   b) the measured KPI meets or exceeds a given threshold.
(2) wherein said users are segmented to different user clusters and wherein said method further comprising:
   identify at least one cluster of users, designated statistically distinct segment of users, that shows a statistically significant preference for one of the at least two generated media assets based on the measured KPI performances for the respective cluster of users,
   apply the method steps (i) to (viii) independently for each identified cluster of users.
(3) wherein the generated media assets conform to asset constraints, the constraints including at least preserving specific at least one semantic element of the select media asset in the later generated at least two media assets.
(4) wherein selecting exploration directions in the latent space is done by using techniques selected from the group that includes: simulated annealing, evolutionary algorithms, or training a model to predict exploration directions.
(5) wherein selecting directions comprises applying an the exploration exploration/exploitation policy that determines whether the directions are selected to increase exploration by generating relatively more diverse or orthogonal directions in the latent space, or to increase exploitation by generating directions more closely aligned with a previously successful exploration direction.
(6) wherein the maximal controlled distance ‘epsilon’ is configured: manually, experimentally, or using a critic model.
(7) wherein configuring the maximal controlled distance epsilon comprises applying an exploration/exploitation policy that determines whether the controlled distance is set closer to the upper bound of epsilon to increase exploration or set to a smaller distance to increase exploitation.
(8) wherein conducting the A/B test comprises dynamically allocating user traffic to the generated media assets using a multi-armed bandit algorithm that increases allocation to variants exhibiting higher KPI performance and decreases allocation to variants exhibiting lower KPI performance.
(9) wherein creating the at least two controlled variations of the latent vector comprises selecting, for each variation, at least one of (i) a latent-space distance and (ii) an exploration direction, according to an exploration/exploitation policy, the policy determining whether the controlled variations are generated with relatively larger distances to increase exploration or relatively smaller distances to increase exploitation, and further determining relative orthogonality among the exploration directions.

According to another aspect of the presently disclosed subject matter there is provided a system for iterative media asset generation and optimization, comprising, by a Processor and Memory Circuitry (PMC) configured to:
provide a pre-trained generative model and a media asset in a media space;
encode, by the generative model, the media asset into a latent space vector within a smooth or semi-smooth latent space such that controlled variations in the latent vector correspond to controlled semantic or visual variations in a corresponding media asset;
create, in the latent space, at least two controlled latent variations of the latent vector, each variation being a latent space vector at a maximal controlled distance epsilon from the latent vector and generated along an exploration direction;
generate, using the generative model, at least two media assets corresponding to the controlled variations, the generated assets exhibiting controlled asset variations relative to the media asset or a previously selected media asset;
conduct an A/B test by presenting the generated media assets to users and measuring KPI performance associated with a KPI type;
select the generated media asset having the best measured KPI performance;
when the measured KPI of the selected media asset fails to satisfy an exit criterion,
repeat the encode, create, generate, conduct and select operations with respect to the selected media asset as the media asset for the next iteration; and output the selected media asset when the exit criterion is satisfied.

In addition to the above features, the system according to this aspect of the presently disclosed subject matter can comprise one or more of features (1) to (9) listed above mutatis mutandis, in any desired combination or permutation which is technically possible.

According to still another aspect of the presently disclosed subject matter there is provided a non-transitory computer readable storage medium tangibly embodying a program of instructions that, when executed by a computer, cause the computer to perform a method of iterative media asset generation and optimization, comprising:
(i) providing a pre-trained generative model and a media asset in a media space;
(ii) encoding, by the generative model, the media asset into a latent space vector within a smooth or semi-smooth latent space such that controlled variations in the latent vector correspond to controlled semantic or visual variations in a corresponding media asset;
(iii) creating, in the latent space, at least two controlled latent variations of the latent vector, each variation being a latent space vector at a maximal controlled distance epsilon from the latent vector and generated along an exploration direction;
(iv) generating, using the generative model, at least two media assets corresponding to the controlled variations, the generated assets exhibiting controlled asset variations relative to the media asset or a previously selected media asset;
(v) conducting an A/B test by presenting the generated media assets to users and measuring KPI performance associated with a KPI type;
(vi) selecting the generated media asset having the best measured KPI performance; when the measured KPI of the selected media asset fails to satisfy an exit criterion,
(vii) repeating stages (ii)-(vi) using the selected media asset as the media asset for the next iteration; and
(viii) outputting the selected media asset when the exit criterion is satisfied.

In addition to the above features, the non-transitory computer readable storage medium according to this aspect of the presently disclosed subject matter can comprise one or more of features (1) to (9) listed above mutatis mutandis, in any desired combination or permutation which is technically possible.

### BRIEF DESCRIPTION OF DRAWINGS

In order to understand the disclosure and to see how it may be carried out in practice, embodiments will now be described, by way of non-limiting example only, with reference to the accompanying drawings embedded in the description.

FIGS. 1A-1D Illustrate exemplary prior-art images generated by a typical GenAl tool in response to respective user-defined prompts;

FIG. 2 Illustrates, in graphical form, an example of a smooth latent space suitable for use in certain embodiments of the invention;

FIGS. 3A-3C Present a comparative graphical illustration of different A/B-testing variants; (page 15)

FIG. 4 Illustrates schematically a block diagram of a system in accordance with certain embodiments of the invention;

FIG. 5 Illustrates schematically a generalized flow diagram depicting a sequence of operations performed in accordance with certain embodiments of the invention;

FIG. 6 Illustrates graphically a series of media assets produced during an iterative optimization process until a desired media asset is obtained, in accordance with certain embodiments of the invention;

FIG. 7 Illustrates schematically a more detailed flow diagram of a sequence of operations performed in accordance with certain embodiments of the invention;

FIG. 8 Shows a diagram of exemplary latent-space variations generated from a base latent representation, in accordance with certain embodiments of the invention;

FIGS. 9A-9D Illustrate graphically a process of user segmentation together with illustrative examples, in accordance with certain embodiments of the invention; and

FIGS. 10A-10C Present a running example illustrating the operation of certain embodiments of the invention.

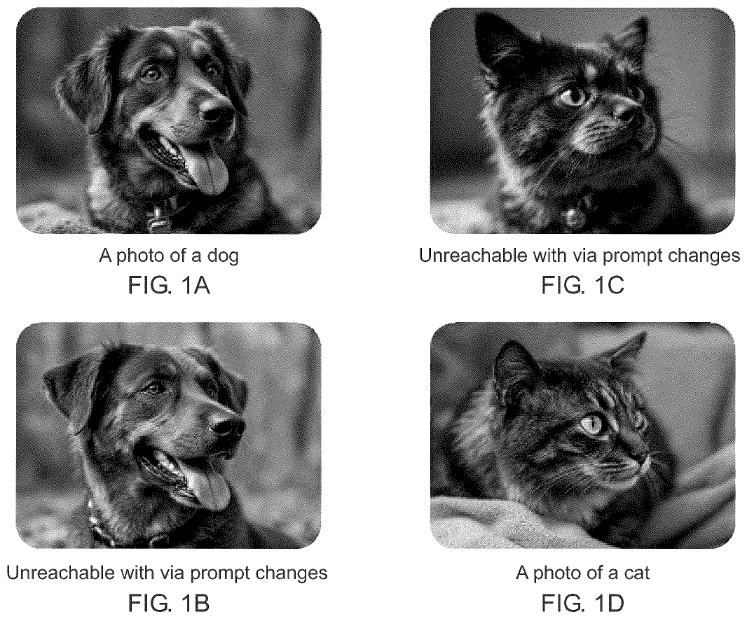

### DETAILED DESCRIPTION

As used herein, a “media asset” includes any form of digital or multimedia content in ‘media space’, including but not limited to images, text copy, videos, audio samples, visual layouts of other assets, or combinations thereof. For example, images may include a product photo demonstrating the proper application of sunscreen on different skin tones or an infographic illustrating the workflow of a two-factor authentication (2FA) process. Text copy may include instructional text on sunscreen reapplication intervals or a step-by-step guide for setting up 2FA on a mobile device. Videos may include an educational clip explaining the importance of broad-spectrum sunscreen or an animated walkthrough of a secure login process utilizing 2FA. Audio samples may include a voiceover providing reminders to reapply sunscreen during outdoor activities or auditory cues guiding users through a 2FA verification step.

As used herein, a “visual layout of other assets” may include the arrangement and structural design of multiple elements within a media composition, including but not limited to text, images, videos, icons, buttons, and interactive components. Non limiting examples include:
a) an e-commerce product page with images, pricing, and call-to-action buttons arranged to enhance user engagement;
b) a graphical user interface (GUI) comprising control panels, input fields, and navigational menus optimized for usability;
c) an engineering dashboard displaying dynamically updated graphs, heatmaps, and statistical summaries positioned to maximize interpretability; and
d) an augmented reality (AR) environment where virtual objects, labels, and interactive markers are spatially aligned with a real-world view to improve contextual relevance.

For a better understanding of certain embodiments and aspects of the present invention there follows a discussion of certain terms generally known per se that will be utilized in the various embodiments of the invention. The invention is by no means bound by the definitions of these terms which are provided for clarity of explanation only.

Latent spaces are a lower-dimensional (w.r.t. the data space), abstract numerical representation of data that captures underlying structures in the original high-dimensional data space. It is a compressed and organized n-dimensional space where similar data points can be semantically organized.

Latent spaces in generative models arise either from their internal representations or from specific types of generative models, like diffusion models, which learn to map data into an alternative representation space.

ML models, including generative models, learn to extract meaningful features and representations from the data as they map them to the latent space in their training process. The semantics of a latent space depend on the training data; a large, generic dataset results in a general latent space, while a small, specialized dataset produces a latent space with more specific semantics.

Pre-trained models (PTMs) such as BERT, GPT and StableDiffusion are machine learning models with sophisticated pre-training objectives and huge model parameters. PTMs can effectively capture knowledge from massive labeled and unlabeled data. The rich knowledge implicitly encoded in huge parameters and induced latent spaces can benefit a variety of downstream tasks, which has been extensively demonstrated via experimental verification and empirical analysis.

In the description below the latent space is used but is not confined to what media assets this latent space can represent.

One of the desirable features of the latent space is its smoothness—in such latent spaces, controlled changes in latent coordinates correspond to controlled changes in generated data. This may be defined as: “Smooth latent spaces ensure that a perturbation on an input latent corresponds to a steady change in the output image.”

The smoothness of latent space is governed by the training process of the model, meaning that not all latent spaces are smooth, but there is ample research on creating smooth latent spaces) and manipulating latent representations. In accordance with certain embodiments, the latent space is either smooth latent spaces or semi-smooth. Semi-smooth latent spaces is construed to include: latent spaces which preserve the smoothness property only over a subset of the space. For example a latent space which preserves smoothness only on an n-dimensional sphere as in arxiv.org/abs/2306.08687.

As used herein, a “smooth” latent space is construed to include one in which controlled variations to a latent space vector result in correspondingly ‘small’ changes in the generated media's semantic (e.g. in the case of text) or visual features.

For media asset encoding latent spaces, semi-smoothness can be verified by sampling small perturbations around various points in the latent space and examining the generated media differences. For instance, one can define a small ball B (z, δ) around a reference latent point f(z′), z′∈B (z, δ) and measure semantic distances using image or text similarity models (e.g., cosine similarity in CLIP embeddings). If these semantic distances remain bounded by a small threshold across the entire ball B (z, δ) the latent region around z is classified as semi-smooth. Regions failing this test can either be excluded from the search trajectory or treated with custom constraints or a specialized fallback model.

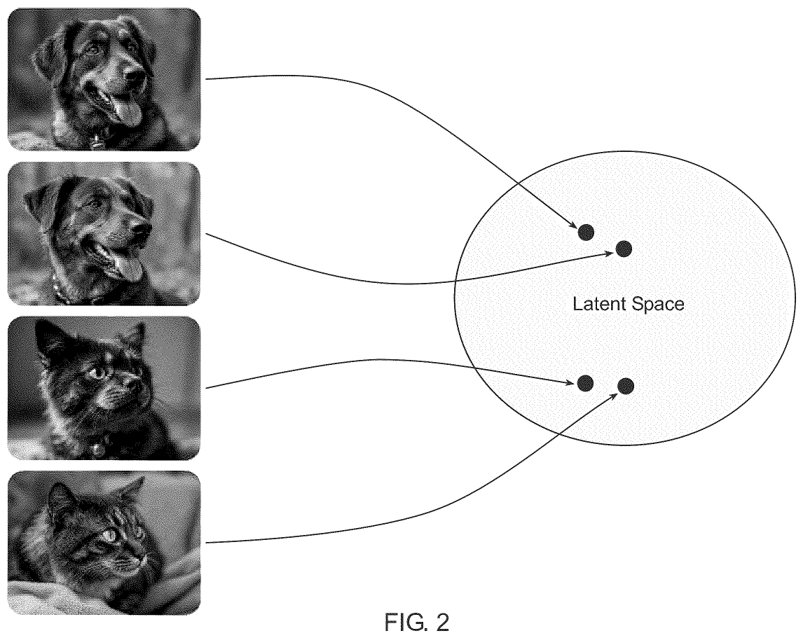

FIG. 2 depicts a “smooth” latent space, where points closer together represent semantically or visually ‘similar’ concepts, and small transitions in the latent space result in small changes in the media asset in media space or correspond to controlled semantically or visually changes in the corresponding media asset (namely ‘controlled changes’ can be achieved for example by choosing an exploration direction and a maximal controlled distance epsilon both will be explained in details below). While points farther apart represent different concepts and bigger changes in the generated media.

Differentiability with Respect to the Latent Space

In certain problems, it is possible to find the exact derivative of a certain “KPI” with respect to the latent representation of the media asset. An example is a generative text model and a Sentiment Analysis “KPI”. In such a case, there are available models for predicting the sentiment of a sentence with super-human accuracy, modeling our “KPI” near perfectly. Thus, there is a function: S (G (z)): Z->[0, 1] where S is the sentiment analysis model, G is the generative text model, and Z is a latent space of the generative text model. Such a function is fully differentiable, thus enabling us to find optima (at least locally) with gradient based methods.

In our case, such a “KPI” modeling function does not exist, or is very expensive to approximate, resulting in a black box optimization problem.

### A/B Tests

A/B testing is a user experience research method. A/B tests consist of a randomized experiment that usually involves two variants (A and B), although the concept can be also extended to multiple variants of the same variable. It includes application of statistical hypothesis testing or “two-sample hypothesis testing” as used in the field of statistics. A/B testing is a way to compare multiple versions of a single variable, for example by testing a subject's response to variant A against variant B, and determining which of the variants is more effective.

The tests results can be analyzed using different common statistical methods (from wiki):

| Assumed | | | Alternative |
|---|---|---|---|
| distribution | Example case | Standard test | test |
| Gaussian | Average revenue per user | Welch's t-test | Student's t- |
| | | (Unpaired t-test) | test |
| Binomial | Click-through rate | Fisher's exact test | Barnard's |
| | | | test |
| Poisson | Transactions per paying | E-test | C-test |
| | user | | |
| Multinomial | Number of each product | Chi-squared test | G-test |
| | purchased | | |

There is also known the Bayesian method for analyzing A/B testing results.

### Multi-Armed Bandit Variant of A/B Tests

A problem of A/B tests is that since some variants may perform worse than the baseline, there is an “opportunity cost” associated with the test—i.e. there will be some “lost” conversions due to the test.

To lessen this effect, one could use a multi-armed bandit algorithm as known per-se for assigning variants traffic.

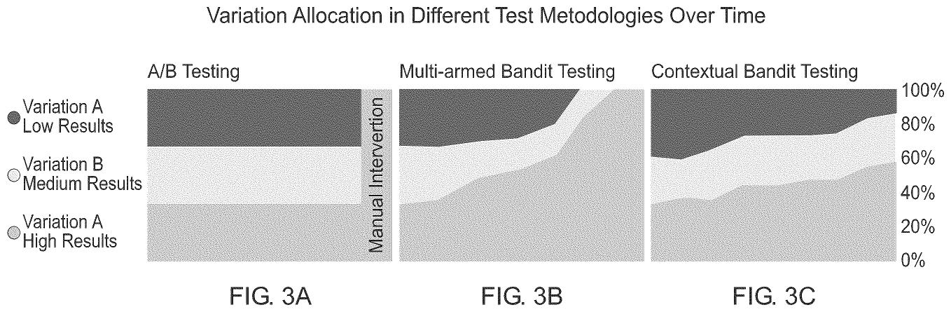

Using multi-armed bandit, the traffic allotment for each variant will be adjusted dynamically according to that variant success, where “losing” variants will receive less traffic over time. This can be shown in the diagram in FIGS. 3A-C.

### Personalization and User Segments

The aforementioned problem is even harder when considering the fact that different users, or user clusters, might have different “optimal” assets due to various reasons such as demographics, capabilities, cultural differences, time and date, current events, etc.

State-of-the-art content personalization (as described in arxiv.org/pdf/2304.00377) approaches in machine learning can be grouped into 2 main categories:
1. Predictive: these methods try to predict which content out of a pre-fabricated pool of assets will be best for a certain user.
2. Generative: these methods try to generate new content which will be best for the user.

Each of these 2 categories has 2 sub-categories which are:
1. Target-specific Models: These models are developed and trained specifically for a single user, tailoring predictions to the individual's characteristics or behavior.
2. Group-specific Models: This approach involves training separate models for specific groups of users based on shared profile characteristics or demographics.

The limitation of predictive approaches lies in their reliance on a predefined pool of assets, which may not include the optimal choice for a given scenario.

Generative approaches solve the problem of confinement by creating new assets beyond the predefined pool, but they are flawed because patterns from past data often fail to generalize to new users.

The only reliable way to achieve effective generalization is by testing the generated assets (which are educated “guesses”) directly with new users.

### DESCRIPTION OF CERTAIN ASPECTS AND EMBODIMENTS OF THE INVENTION

In accordance with certain embodiments, the following proposed method aims to find desired media assets by iteratively searching the generative model's inner representations (“latent space”), while grounding the search by presenting intermediate solutions to a judge using “A/B tests”. The judge can be real human audiences (e.g. users or real users), a GPT model, or any combination thereof.

It does so by generating “controlled media variations” of the media asset at each of the algorithm's “steps” and evaluating their performance through an “A/B test” based on the resulting “KPI”. These “controlled media variations” are created by encoding the media asset into a latent space representation using a pre-trained generative model, generating two or more vectors (referred to as “controlled latent variations” or “latent space vectors” (or vector variations) from the latent space vector representation, and then sampling the generative model with these modified latent vectors. These are “controlled” in the sense that their latent representations are below a determined maximum distance epsilon from the latent space representation according to some metric on the latent space for example cosine similarity, Euclidean distance or other known metrics.

The results of the “A/B test” are fed back into the process generating the “controlled latent variations,” allowing the creation of variations that are more likely to perform better based on the “KPI.”

Thus, put simply, and for a better understanding only, in accordance with certain embodiments, the invention provides for a computerized method for iteratively generating and optimizing digital media asset, including images, text, video, audio, and layout compositions—using a pre-trained generative AI model and measurable Key Performance Indicators (KPIs). The system addresses a long-standing challenge: current A/B testing and content-optimization pipelines rely heavily on manual human selection, intuition, and prompt-engineering, which produce biased and inefficient results. The invention instead introduces a fully automated, closed-loop optimization engine grounded in the mathematical structure of a smooth or semi-smooth latent space of a generative model.

Thus, in accordance with certain embodiments, the method begins by encoding a given media asset into a latent space, where small, controlled variations (bounded by an epsilon) correspond to predictable semantic or visual variations. In each iteration, the system generates at least two “controlled latent variations”, decodes them back into media-space assets, and evaluates them using A/B testing (optionally using a multi-armed bandit scheme). KPI performance determines which variant becomes the seed for the next iteration. This produces a search trajectory through latent space that gradually climbs toward KPI-optimal assets.

In accordance with certain embodiments, the invention also includes optional modules for:
User segmentation—automatically identifying user clusters exhibiting statistically distinct preferences, and running separate optimization loops per segment.
Asset constraints—preserving designated semantic elements (e.g., product pixels, object boundaries, phrases) during generation.
Advanced exploration direction selection—using e.g. simulated annealing, evolutionary algorithms, or models trained to predict optimal latent-space directions.

The method outputs the selected or KPI-optimal media asset when an exit criterion is met (e.g. no further improvement or KPI≥threshold). The approach generalizes to any media type and KPI, enabling platform operators, content creators etc., to automatically and I discover high-performing content while minimizing or eliminating the reliance on human guesswork.

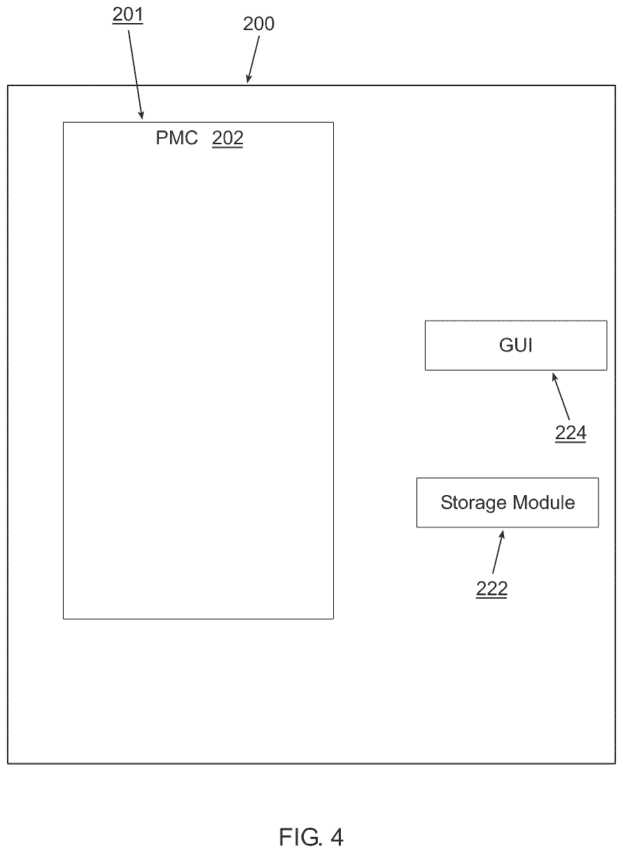

Before moving on attention is drawn to the FIG. 4, illustrating a generalized block diagram of a system finding desired media assets by iteratively searching A generative model's inner representations (e.g. “latent space”), in accordance with certain embodiments of the presently disclosed invention.

The system 200 illustrated above can be used for generating and optimizing media assets by iteratively searching a generative model's (GenAl) inner representations (“latent space”), in accordance with certain embodiments of the presently disclosed invention), all as will be explained in greater detail below.

According to certain embodiments of the presently disclosed subject matter, the system 200 comprises a computer-based system 201 for performing the processing steps described herein in accordance with various embodiments of the invention

Specifically, system 201 includes a processor and memory circuitry (PMC) 202 operatively connected storage 222 and to GUI for communicating with user or users. PMC can perform the necessary operating the system, as further detailed herein. It may comprise one or more processors (not shown separately) operatively connected to a memory (not shown separately). The processor(s) of PMC 202 can be configured to execute several functional modules in accordance with computer-readable instructions implemented on a non-transitory computer-readable memory comprised in the PMC. Such functional modules are referred to hereinafter as comprised in the PMC.

According to certain embodiments, system 201 can comprise a storage unit 222. The storage module 222 can be configured to store any data necessary for operating system 201.

In some embodiments, system 200 can optionally comprise a computer-based Graphical User Interface (GUI) 224 which is configured to enable user-specified inputs related to system 201.

It is noted that the system illustrated in FIG. 2 can be implemented in a distributed computing environment,

The description below includes reference to computational stages that may be performed in system 200.

### Exploring the Latent Space

In accordance with certain embodiments, the smoothness properties of certain latent spaces Is used to generate semantically or visually similar variations from an existing media asset, allowing such variations to be “controlled”. Meaning for example that one can choose how large of a semantic/visual change one would like to get from these variations. This allows us to get variations which are both extremely small or large in change magnitude.

To achieve “controllability” over the generated media variations, the latent variations are constrained to remain within a defined threshold epsilon based on a metric in the latent space. This metric could be, euclidean distance, cosine similarity, or others. As previously mentioned, in a smooth latent space, points that are closer together produce similar media assets, while points farther apart result in entirely different media assets (e.g. in terms of small semantic or visual changes).

As discussed, a defined (e.g. “upper”) threshold epsilon may govern the maximum permissible change or a maximal controlled distance in the latent space (wherein the latent space is either smooth or semi-smooth) for generating controlled variations of a corresponding media asset (corresponding meaning to the ‘encoded’ media asset after creating the controlled variations of the latent space vector (resulted from said encoding), wherein the controlled variations include at least two latent space vectors characterized by a maximal controlled distance epsilon from said latent space vector). In one example, epsilon is measured using an l2 norm, i.e., ∥z new−z original∥l2≤epsilon, ensuring that the new latent vector z new remains close to z original in latent space. This “closeness” preserves semantic or visual similarities (namely controlled semantically or visually changes) in the generated media assets (as explained in detail throughout the spec). The specific value of epsilon may be determined:
1. Manually (e.g., by a domain expert chooses a predefined epsilon value),
2. Experimentally (e.g., systematically varying epsilon and measuring A/B tests according to ‘historic’ data of A/B testing KPI values associated with a KPI type explained in later sections) for example by training a machine learning (ML) model known in the art, or
3. Using a Critic Model (e.g., a neural network such as CLIP that estimates the semantic distance between two images).
   In one non-limiting example, for a 512-dimensional latent space, epsilon in the range of 5-15 (measured in l2 norm) often yields moderate visual changes without altering the subject matter of the asset. This cardinality can be manually calibrated upon initialization.

Exploring the space of possible media assets using “controlled variations” is possible since the magnitude of the asset change is loosely correlated to the magnitude in change of the measured “KPI” induced by it.

In accordance with certain embodiments, this assertion rests on well-established principles in psychology and behavioral science:
Weber's Law: This principle from psychophysics states that the ability to perceive a difference between two stimuli is proportional to the magnitude of the original F perceptual threshold and fail to elicit behavioral responses.
Impact of Visual Hierarchy: Studies in UX design consistently find that larger, more noticeable changes (e.g., altering a headline or hero image) have a greater impact on engagement metrics compared to minor tweaks (e.g., button shading or border adjustments). These findings are well-documented in usability research).
Ad Absurdum Example: If no changes are made to an asset, no variation in KPIs can occur, rendering any experiment futile. Replacing an asset entirely would most likely change the induced KPI (for better or for worse).

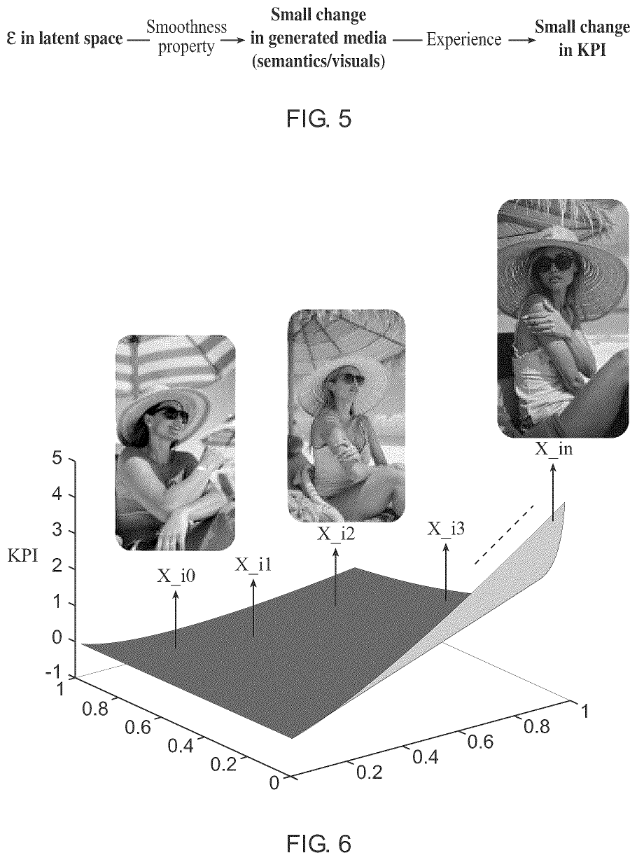

This line of reasoning leads to the following connection (see FIG. 5):

Meaning that small changes (epsilon) in the latent space generates small changes in the “KPI” induced by the media asset.

This connection enables exploring the latent space using a “trajectory” approach, which involves generating “controlled media variations” and making adjustments to the latent representation based on the variants that perform best according to the “KPI” in an “A/B” test.”

In each algorithm step, “controlled media variations” are created using information from previous steps and enjoying the smoothness properties of the “latent space”. The “controllability” allows us to choose the change magnitude according to an exploration/exploitation tradeoff (will be discussed later), with the overall goal of reaching the global “KPI” maxima.

The process for finding a desired media asset (namely ‘best’ media asset or ‘optimized’ media asset or selected media asset) is illustrated in FIG. 6. In this example, a 2-dimensional latent space is depicted with a third “KPI” dimension superimposed. The arrows represent various “latent variations” within the 2D latent space (their direction is purely for clarity). The Z-axis (“KPI”) value of each point indicates the “KPI” associated with that specific “media variation.” For clarity, only one variation is shown per step, but in practice, multiple variations are generated at each step.

Diagram of a 2-D Latent Space with the KPI Dimension Superimposed

In this diagram a media asset (image related to “sun exposure” from the example above), which is described by the latent vector x_i0 and induce a certain measured “KPI” (0.5 in the example above) is provided. Different latent vectors in this space correspond to different images, and induce different “KPI's” (x_i0: 0.5, x_i1: 1, x_i2: 1.5, x_i3: 2, x_in: 4). As described above, due to conjecture 1, similar latent vectors induce similar “KPI” which is shown in the diagram by the fact that there is a smooth “KPI” surface.

### Algorithm Description:

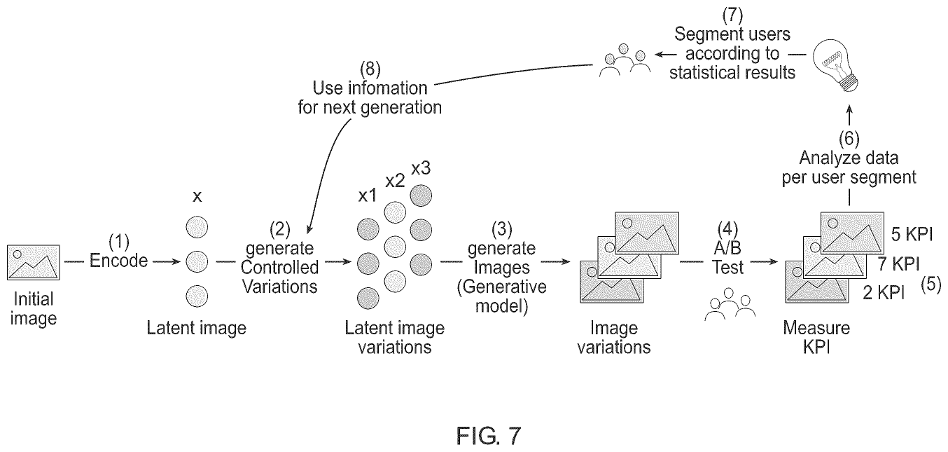

FIG. 7 illustrates a diagram of the algorithm of the proposed method in accordance with certain embodiments. For simplicity, one can use an image as the media but other media kinds (such as text, video, audio etc) are applicable as well.

Algorithm Steps in Accordance with Certain Embodiments:
(1) Encode a media asset (in this case an image) into a latent space using a pre-trained generative model. x is the encoded asset vector. This encoding can be done in numerous ways such as integrating the ODE forward in time as proposed by https://arxiv.org/pdf/2011.13456 in the “Manipulating latent representations” section (for a score based image generation model).
(2) Generate “controlled variations” of the latent representation in the latent space. x1, x2, x3 (3 variations are an example) are the latent space variations vectors. Note that, generally, the controlled variation encompass generating at least two latent space vector variants. These “controlled variations” (namely latent space v; FIG. 7 pr latent space vectors) will be the next step in the search “trajectory”. Several methods for achieving this will be discussed later in the “Choosing exploration directions in the latent space” and “Exploration/Exploitation” sections of this document. x1, x2, x3 are to be with maximum controlled distance (namely determined threshold) of “epsilon” from x in the latent space. The value of “epsilon” can be configured before starting the algorithm or by calibrating it as described above.
(3) Use the “controlled variations” to generate novel media assets (in this case images) using a generative model (e.g. “decoding”). Each generated latent space vector (variant) will result in corresponding generated media asset. Here the “smoothness” property of latent spaces is utilized as described above so the generated media assets will be similar semantically and/or visually, which the case may be. This “decoding” can be done by integrating the ODE in backwards in time (for a score based image generation model). Note that with respect to the specified (2) and (3) stages, the controlled variations of latent space vectors in the latent space will result in controlled changes in the corresponding generated media assets. However, typically, the controlled variations in the latent space cannot regulate specific media asset elements in the corresponding generated media asserts. Thus, by way of example assuming a sunscreen-themed media asset, the controlled variation of the latent vectors cannot be “planned” in-advance to result specifically in, say alterations to the background color temperature (e.g., from a warm pastel yellow to a neutral cream tone) of the generated media asset. It can however result in a small, yet not predictable (or specific) elements in the resulting media asset. As maty be recalled, controlled variations may qualify as “small” changes, e.g. by setting a desired small epsilon threshold. As further discussed herein, there is an option to impose certain invariance on elements of the media asset by following the “asset constraints” computational stage, discussed in details herein. Conduct an A/B test experiment e.g. which includes presenting the generated media assets to users (real or virtual e.g. GPT). An A/B test can be any of the tests described in the “A/B tests” section above. In some examples the A/B test r=traffic can be regulated using multi-armed bandits. The definition of the test has to include a “KPI” type objective. In some examples of the present description, A/B tests are used to present to users with intermediate solutions to the optimization problem of the media asset (e.g. media asset variants or generated media assets in media space e.g. using the pre-trained generative model).
(4) By measuring user responses (e.g. KPI performance or values according to the KPI type to these presented media asset variants, the A/B test helps identify what is the “best” media asset from among the displayed ones and further facilitates which “exploration directions” in the latent space align with user preferences and behaviors. Note that In some examples, the next iteration will commence starting from the ‘best’ media asset that was selected out of the presented variants (based on its measured KP). This iterative feedback mechanism allows for a more efficient search for the optimal or best media asset by leveraging actual user input to guide the refinement process. This information is then fed back to the process generating the “controlled variations” in an automatic fashion.
(5) Bearing this in mind, If the measured KPI associated with the selected media (e.g. ‘best’, or ‘optimized’) media asset fails to meet an exit criterion, the next step would be setting the selected media asset as the media asset for use in the next iteration Measure the “KPI” value induced by each of the generated media assets.
(6) Analyze the results (of step 5) using statistical tests such as described in the “A/B tests” section above to uncover which media asset performed “best”, the process iterations continues until the exit criterion is met.

In accordance with certain examples, personalization and User segments may be applied, for instance:
(7) Users are segmented to different user clusters checking if there is at least one cluster of users, designated statistically distinct segment of users, that shows a statistically significant preference for one of the at least two generated media assets based on the measured KPI performances for the respective cluster of users, wherein whether a cluster qualifies as statistically significant is determined based on one or more predefined thresholds, including configurable hyper-parameters set in advance for purposes of controlling operation of the algorithm. The method steps may be applied independently for each identified statistically distinct segment of users or check if there is a subset of users with certain properties (such as but not confined to the properties outlined in the “User segments” section above) that shows a statistically significant preference for one of the media asset variations (e.g. according to the KPI of step 6), based on the same or different predefined thresholds. If so, for each such user segment apply the specified method steps as will be elaborated in the “Segmenting users” section in the document
(8) Use the information gained by the experiment and analyzed in (6) to condition the next iteration (e.g. choosing the best media asset to be encoded) of creation of “controlled” latent variations. This is elaborated both in “Segmenting users” and “Choosing exploration directions in the latent space” sections.

As explained above, controlled (e.g., small) changes among latent space vectors in the latent space, typically, cannot regulated specific in-advance, designated changes in the corresponding generated media assets. However, small (yet not specifically designated in advance) changes can occur in the media asset in response of small changes in the latent space vectors. For clarity, There follows (with a reference to a specific non-limiting “Sunscreen Context” example) a few exemplary “small changes” that may occur in a media asset in response to generating small changes in latent space vectors. Thus:

Small semantic or visual variations (Sunscreen Context) In accordance with certain examples, a “small semantic or visual variation” in a sunscreen-themed media asset might involve resulting in slight alterations to the background color temperature (e.g., from a warm pastel yellow to a neutral cream tone) while retaining the sunscreen bottle as a central object. Another minor variation could include adjustments to the brightness or contrast levels while the sunscreen remains clearly identifiable, but the overall aesthetic changes “subtly”, another example is presented in a former section e.g. “Diagram of a “smooth” latent space” with presented the “small” visual variation between the two cats and the “small” visual variation between the two dogs. In a semantic variation (e.g. text-based), an existing tagline such as “Protect Your Skin. This Summer” generated result can be e.g. “Stay Sun-Safe This Summer,” i.e. the main message was preserved while offering a “small” semantic change or “fresh phrasing”. These controlled variations remain within an maximum epsilone-distance threshold in the latent space (from the encoded media asset), ensuring that the core semantic elements—namely, the presence of sunscreen and messaging about UV protection, or the face that the animal is a “cat” or a “dog”—stay intact, but the visual or textual details differ in a way that can be measured and optimized through the iterative A/B testing process described herein. By systematically exploring variations as described in detail herein, the system can identify which refinements produce the best user engagement KPI, such as increased reading time or interaction with educational sun-safety tips (namely the ‘best’ media asset or a media asset that meet an exit criterion). The invention is not bound by these examples. Note that whereas the latter examples illustrated, e.g. small changes in the generated media assets, these changes may be achieved by first generating latent space vector variants in the manner specified.

In accordance with certain embodiment, the following challenges are encountered and will be discussed in more detail below:
(1) How to “select” latent variations, i.e., what direction to choose when creating controlled variations e.g. “exploration directions” and step magnitude in the latent space search, as detailed in the “Choosing directions in the latent space” and “Exploration/Exploitation” sections.
(2) How to ensure the generated media adhere to specific constraints (such as product fidelity, realism, art guidelines, etc.), as explained in the “Asset constraints” section.
(3) How and when to decide to split user segments, as described in the “Segmenting users” section.
(4) The stopping condition, as outlined in the “Exit criterion” section.

In accordance with certain embodiments, one or more of the following advantages are obtained over past solutions used for optimizing media assets including:
(1) benefiting from the smoothness property of latent spaces and “KPI”, which enables efficient search within the media space associated with a predefined key performance indicator (KPI) type.
(2) There is no limitation by the media variations produced by generative models, such as prompts (such as DALL-E, MIDJOURNEY etc.).
(3) The magnitude of generated media assets variation can be controlled by adjusting the variation distance in the latent space, or, in simple words, we can control the extent of the changes between media assets by controlling the extent of changes in the corresponding latent space vectors.
(4) Flexibility to define asset constraints that are defined in the media space and may be “implemented” within the latent space.
(5) The user interacts with the system in the media space (e.g. participates in the A/B test for selecting “best” media asset for use in the next iteration, but media assets are transformed form the media space to the latent space whereupon the computational stages are implemented (for generating latent space vector variants in the manner specified above) and the latter latent vectors variants are then transformed back to the media space for presenting the resulting, media assets to the user. All these computational steps are implemented in an iterative manner until exit criterion is achieved, as discussed in details herein.
(6) The user of the method does not need to manually select the “exploration directions”.

Turning now to the various challenges discussed above they are explained herein by way of example only, thus:

### Choosing Exploration Directions in the Latent Space

Choosing “exploration directions” in the latent space traversal for the creation of the “controlled variations” is a challenging problem. These are directions in the latent space from the latent representation x (as shown in the diagram above) to the generated variations x1, x2, x3 (3 is an example).

Several non-limiting methods are described for choosing these “exploration directions”, though they are not exhaustive. It's important to emphasize that the following methods are not binding.

One approach would be to use Simulated Annealing, i.e. choosing random directions while focusing in areas of higher success, while decreasing the temperature and distance from the last solution. The problem with this approach is that not all points in the latent space map to valid assets, and that the search itself is random and inefficient. There are works that try to overcome this in several ways such as (https://openreview.net/pdf?id=F7LYy9FnK2x, https://proceedings.neurips.cc/paper files/paper/2023/file/b49213694c3e752252d62ca360b7 2a36-Paper-Conference.pdf). Sampling multiple directions in this method is may be utilized.

An alternative non-limiting approach is to select pre-determined directions that have been identified as effective through user preference research (for example, directions corresponding to words like “pretty” or “nice”) and combine them into different sets using evolutionary algorithms (arxiv.org/pdf/1805.11014). In the first iteration of the algorithm, the directions will be chosen based on the user preference research. These directions will then be used to generate the first “generation” of latent variations (for example each direction will correspond to a prompt for a text-to-image generative model). After the test is concluded, the analysis of the test results will help identify the “surviving” assets. These assets' directions will be recombined in the next iteration to generate the next “generation” of media assets. These directions can then be used for manipulating the latent representations (as in arxiv.org/pdf/2410.10792 for images). Sampling multiple directions using this approach can be done by keeping a list of n (n is the number of x variations) best directions to recombine from.

Another non-limiting approach is to train another model to predict such directions (or the variations themselves, i.e. directions and distance) using past user-interaction data. Such a model can also be conditioned on previous iterations data collected from “real” users using A/B tests as mentioned above. This alleviates the need for choosing pre-determined directions which might be biased. A possible way to do that is to train a model for predicting human preferences of media assets as in arxiv.org/pdf/2305.01569 (for images) and then use its gradients as guidance for the generation process (as done in e.g. proceedings.mlr.press/v202/song23k/song23k.pdf for a diffusion image generation model). Such an approach is similar to a critic function in an actor-critic reinforcement learning setting (link). Sampling multiple directions using this method is not straightforward but can be done by using stochastic models as the directions prediction model (such as diffusion models) and sampling multiple times. Another approach is to add some gaussian noise around the predicted direction from the model.

### Exploration/Exploitation

In accordance with certain embodiments, Exploration and exploitation are two fundamental strategies in search algorithms that play a role in finding optimal solutions. Exploration refers to the process of searching new and diverse regions of the solution space, while exploitation focuses on refining and improving the best solutions found so far. Balancing these two strategies is essential for the efficiency and effectiveness of search algorithms. Excessive exploration may lead to slow convergence, while excessive exploitation can result in premature convergence to suboptimal solutions.

The section “Choosing exploration directions in the latent space,” focuses solely on the directions of variations x1 x2, and x2 from x, without addressing their distances. While the distance must remain below the threshold “epsilon” as previously mentioned, its exact value may be determined based on a balance between exploration and exploitation. This distance quantifies the magnitude of change in each variation.

Another factor influencing the exploration/exploitation ratio in a latent space search is the orthogonality of search directions; greater orthogonality indicates increased exploration.

The measured distance and orthogonality measure can then guide the selection of variations based on the desired exploration/exploitation ratio of the search algorithm.

Tuning the exploration/exploitation ratio can be done (but not limited to) by Epsilon Greedy or Thompson Sampling algorithms and based on information from previous algorithm steps.

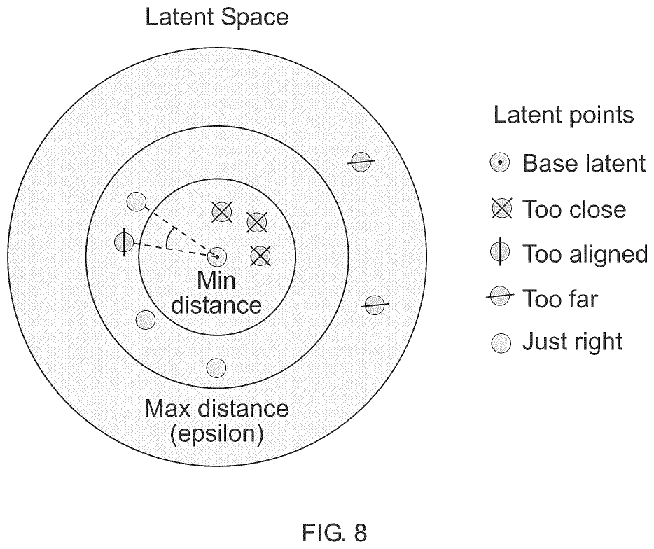

FIG. 8 illustrates a diagram of latent variations created from a base latent representation in accordance with certain embodiments. Depicting the exploration/exploitation tradeoff. All latent points are valid and are suggested by one of the methods described in the “Choosing exploration directions in the latent space” section. The maximum threshold is determined by epsilon and the minimum distance is determined according to an exploration/exploitation policy, and the possible variations are filtered according to it.

Note that there are known in the art methods to determine exploration-exploitation ratio such as epsilon-greedy. For example, utilizing the epsilon-greedy technique, distance and or direction may be determined. For example, in each iteration, with probability 1-epsilon, the system may choose the most exploiting direction and distance given it's method to estimate them, but—with probability epsilon it may choose an exploratory direction and distance. Thus, in accordance with certain embodiments, optimal distance and direction are computed by the system in each iteration, and that the system can choose given a different algorithm (say epsilon greedy) how much to take the optimal perceived direction and distance, and how much to explore.

### Segmenting Users

Another advantage of creating “controlled variations”, is the ability to adapt in accordance with certain embodiments, each media asset to maximize the KPI for different user clusters, provided that they respond differently to various assets. Thus, it is advantageous to consider as much data about the user as possible when examining the test results. Such data may include but not limited to: demographic data, behavioral data, search data, time of day, date and more. This data can be collected via numerous methods such as cookies, tracking pixels, web analytics tools, CRM systems and third party data providers.

By way of example, In the context of the current method, segmenting the general test population into sub populations is done in step (7) of the above algorithm in the following way:

Lets consider the group of all of the collected user attributes A={a_0, a_1, . . . , a_n−1}.

There are 2\hat{ }n possible subgroups of attributes. Our goal is to find subgroups which exhibit preference to a certain media asset/assets in a statistically significant way.

Once such subgroups k0 are found, our next experiment will diverge into k0 distinct experiments in the next algorithm step, and then into k1 distinct experiments in the step after
and so forth:

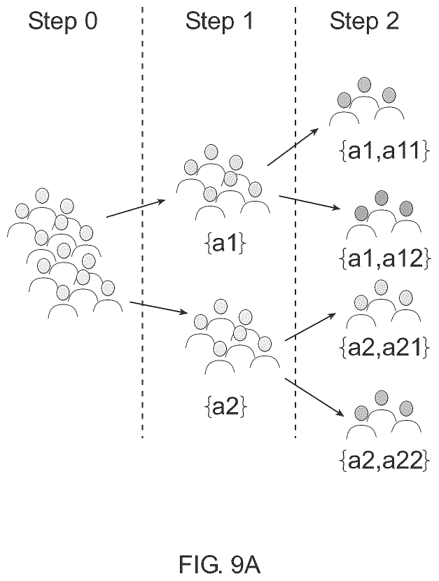

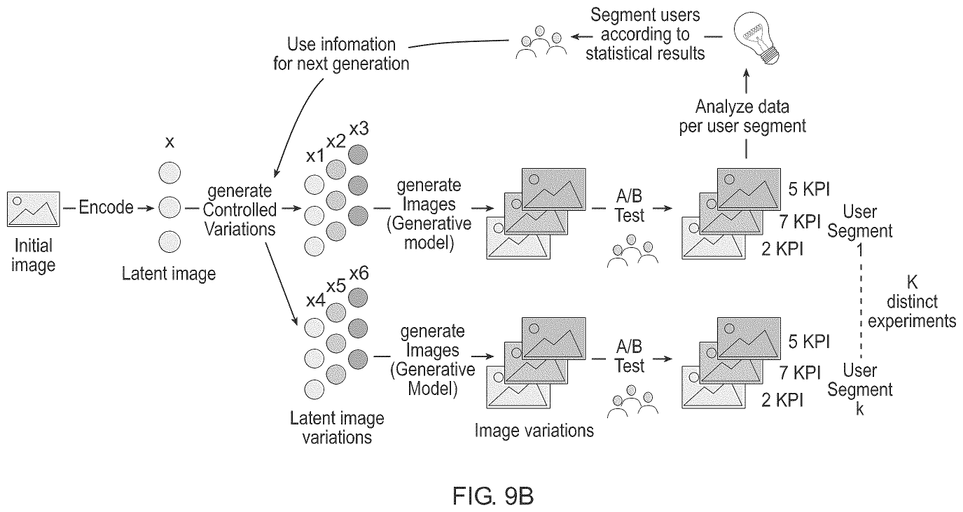

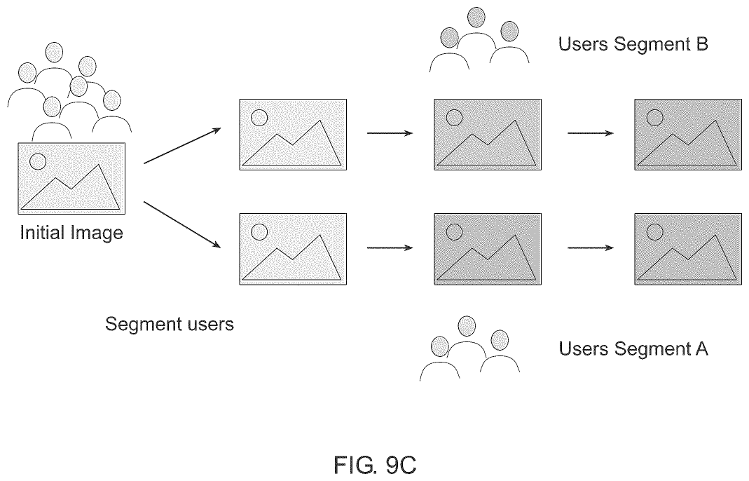

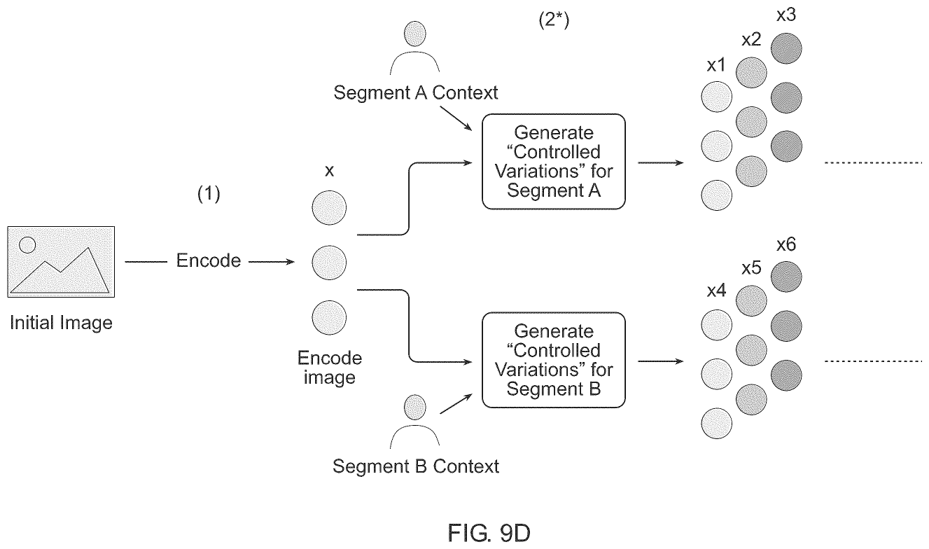

In the diagram of FIG. 9A, one can see that at each step the general population is split into multiple distinct subgroups according to user attributes. Each subgroup will get its own experiment from now on in accordance with the iterative computational stages discussed above.

This allows for adapting the media asset per user segment without making any assumptions about segment preferences before the test is made.

The diagram of FIG. 9B shows the replication of k distinct experiments, one per user segment.

A straightforward approach to identifying such attribute groups is to first sort the attributes by their frequency of occurrence (aiming to create the largest possible groups). Then, perform a brute-force test on each subgroup of up to 5 attributes to determine if it demonstrates a statistically significant preference for a specific asset group. This process should be computationally feasible for up to ^{~}500 attributes on modern parallel hardware. In the subsequent segmentation step, any attributes not previously selected can be included for consideration.

This segmentation of users will result in different search trajectories for each user subgroup (as described above)-different users see different data (see FIG. 9C):

In some examples, user segmentation is performed by analyzing user attributes such as geographic region, age bracket, device type, and prior interaction history. Suppose the system detects that users from Region A exhibit a statistically significant preference for media variations with higher color contrast, while users from Region B show stronger engagement with subtler color schemes. After verifying statistical significance (e.g., p-value <0.01), the user population is automatically partitioned into subpopulations. Each subgroup will go through the steps of the process as explained (I.e. This segmentation logic enables personalization and different search trajectories for each subgroup).

In some examples, to enable faster convergence of the search process for each user segment, one can condition the generative model for creating assets that will resonate with the user segment—there is ample research on the conditioning of generative models beyond text input, e.g. (arxiv.org/abs/2409.19365, arxiv.org/abs/2302.05543, arxiv.org/abs/2312.03701v2). Such methods can be readily modified for conditioning on user data. This means that phase (2) of the main algorithm changes to (2*) and conditions the “controlled variations” creation process on user segment info. After step (2*) the main algorithm continues as is (but replicated across k segments as mentioned above)—see FIG. 9D.

### Asset Constraints

As stated before in accordance with certain embodiments, an important property of the encoded media variations in latent space is that they produce valid media assets after generation, which pass some pre-defined criterion—i.e. follow “constraints” (such as realism, aesthetics, preserve a certain object, are grammatically correct, follow certain guardrails, etc.).

For example, consider an image of a sunscreen cream, for a page that distributes sun protection information as discussed earlier in this document. Our goal is to optimize the image to maximize user attention while ensuring it still clearly represents the sunscreen.

One approach would be to preserve a certain amount of details from the original asset, such as in arxiv.org/abs/2306.00950. Using the sunscreen example, using this approach, the pixels depicting the sunscreen are not changes at all while all the surrounding pixels in the image can be changed. The latter is a non-limiting example of preserving specific at least one semantic and/or element of the select media asset (e.g. the pixels depicting the sunscreen) in the subsequent generated at least two media asset variants.

Below is a non-limiting detailed example of such a process for modifying a media asset in media space (e.g. image) via encoding the media asset by a pre-trained generative model into a latent space vector while preserving an element, say a pre-defined region (being an example of asset constraints)—of the media asset, namely the image in said example. The method involves, applying a structured modification in latent space to the latent space vector, and generating a new media asset (e.g. image) via a diffusion model (e.g. a differential diffusion process ensures that pixels corresponding to a designated region remain unchanged while the surrounding content is modified.

1. Image Encoding into Latent Space
Given a media asset (e.g. an input image I depicting a sunscreen bottle), a pre-trained generative model (e.g. diffusion model) is used to encode the media asset from the media space into a latent space vector (e.g. find its corresponding latent representation).
An inversion method is applied to recover the latent representation z0 such that: z0=f\hat{ }−1, l≈g(z0) where g is the diffusion model forward process and f\hat{ }−1 represents an inversion technique such as:
   DDIM Inversion: Determining a sequence of noise inputs that reconstruct II accurately.
   Score-based Inversion: Iteratively refining the latent to match the observed image.

### 2. Latent Space Modification

A predefined semantic direction vector v is selected based on the desired variation (e.g., background change, lighting adjustment).
A modified latent representation is obtained by applying a transformation.

### 3. Differential Diffusion Constraint

A binary mask M is computed to identify the region corresponding to the sunscreen bottle.
The reverse diffusion process is initialized with the modified latent representation z′.
During the denoising steps, the diffusion model selectively applies updates only to unmasked pixels: xt=D (xt+1,M,θ) where D represents the denoising step, and θ are model parameters.
Pixels corresponding to M are copied from the original image II to the final output at each step, ensuring exact preservation (demonstrating an example of preserving specific at least one semantic element of the select media asset in a later—e.g. following iteration-generated media assets).
The resulting image I′I′ maintains the sunscreen bottle unchanged while exhibiting variations in the background and other non-masked regions.

This method ensures controlled image transformations while preserving essential objects, making it suitable for applications in product imagery, digital asset customization, and content adaptation.

Those known in the art will appreciate that the step above is a step for following “constraints” the step is optional and will be incorporated into the process as explained in detail throughout the spec, the step can be after the “decoding” step and not all the steps of the process are repeated in order to keep it brief, for example choosing exploration direction, A/B testing etc.

A more general approach would be to ensure that some semantics required from the image are preserved, such as composition or persistence of a certain object. Alternatively, methods such as arxiv.org/abs/2208.12242 to achieve such constraints can be used.

This is true for other media assets as well, the above methods can easily be generalized to video, where a “don't change” pixel mask can be created with a time dimension. For text one can keep certain phrases constant or just the general tone (using semantic analysis models and such).

These constraints are an optional part of the proposed method, as for some scenarios there aren't any constraints necessary.

### Exit Criterion

(1) The exit criterion defines when to stop iterating on the algorithm. one can use several non-limiting approaches here such as:
(2) Stopping after k iterations that did not provide improved “KPI” results or the improved results are below a defined gamma value.
   (a) This should be done in tandem with exploring different step sizes as explained in the “exploration/exploitation” section.
   (b) k, and gamma are hyper-parameters of the main algorithm that should be tuned on a case specific basis.
(3) Stop as in (1) but try again after t days. This ensures that the media asset optimization is also accounting for seasonality and trends.
   (a) t is a hyper parameter of the algorithm that should be tuned on a case specific basis.
(4) Stop once a pre-defined “KPI” value has been reached.

In accordance with certain embodiment, the exit criterion is selected from the group that includes:
(a) the measured KPI associated with the selected media asset of the current iteration does not achieve improvement over the measured KPI associated with the selected media asset of a previous iteration;
(b) the measured KPI meets or exceeds a given threshold.

The description exemplified generation of at least two latent vector variants and creating therefrom at least two corresponding media assets (for displaying to the user and applying the A/B testing, all as discussed above). Note, however, that the invention is not bound by these particular examples. Thus, in accordance with certain embodiments at one latent vector variant is generated and corresponding media asset is generated and presented to the user together with one or more previously generated media asset(s) (e.g. generated in a previous and or earlier iteration(s)) and the A/B test is applied the newly generated media asset and the previously generated one (or ones).

In some examples, the method includes selecting the media asset itself for testing (e.g., A/B testing). This enables a direct comparison of performance metrics (e.g. KPI type and associated value) between the “original” media asset and one or more ‘generated controlled media assets’ or ‘generated media assets’-decoded from the associated latent space vector variations namely ‘controlled variations’ via the pretrained generative model. In some cases, A/B testing may involve only the “original” media asset and a single variation, while in other cases, multiple variations may be tested. Additionally, in certain scenarios, the original media asset may be excluded from A/B testing altogether, with the A/B testing conducted solely on at least two generated media assets, each corresponding to a specific controlled variation in the latent space (i.e., each generated media asset is generated from a distinct controlled variation latent vector).

### Full Example

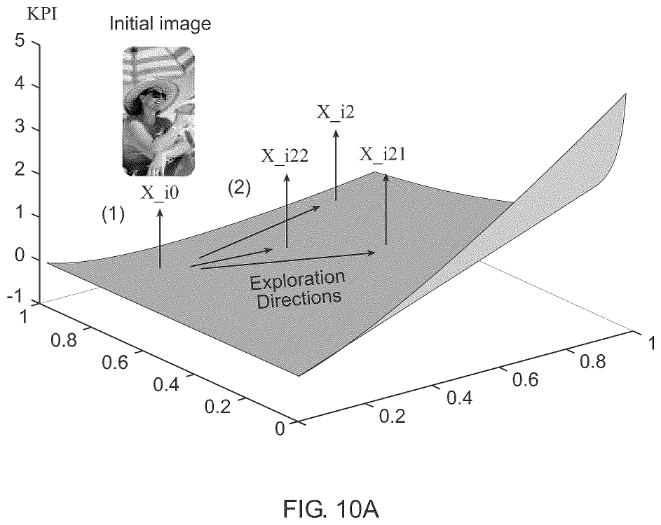

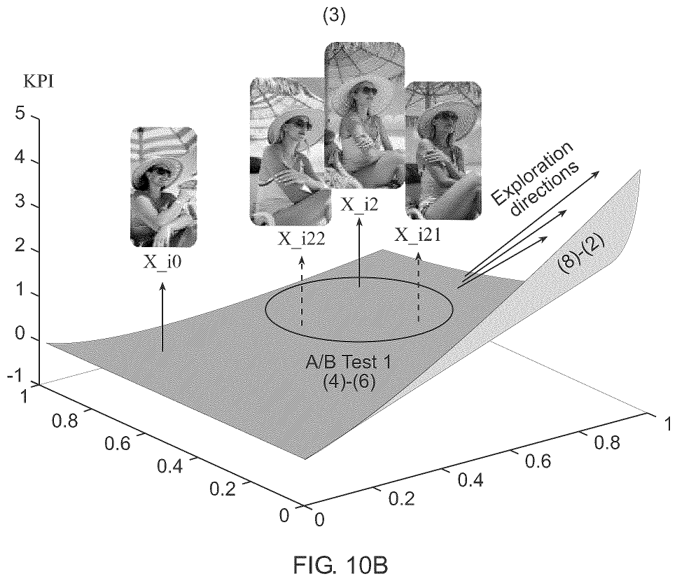

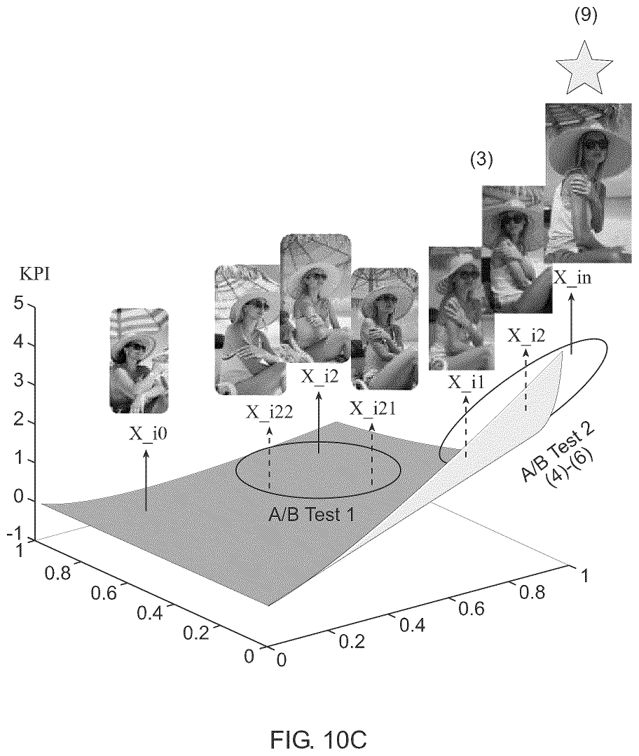

Below is a full example of the optimization process, using 2 experiments. The example is using images for clarity but can be generalized to any other media asset. All algorithm steps pertain to the main algorithm described above in the “algorithm steps” section. In this example (illustrated in FIGS. 10A-10C), a 2-Dimensional latent space is used for clarity, with the Z axis representing a superimposed measured axis (e.g. “KPI” type) (not part of the latent space). The curved surface represents the “KPI” values (associated with the “KPI” type) of each point of the latent space. The upward arrows directions have no mathematical meaning.

### Starting Point:

The algorithm starts in step (1) by encoding an media asset (e.g. image) to a (smooth or semi-smooth) latent space using a pretrained generative model. In this example the initial image is encoded to obtain its latent representation x_i0 (e.g. x_i0 is a latent space vector in latent space associated with the “original” media asset or media asset). Then, in step (2) “controlled variations” {x_i2, x_i21, x_i22} (by this example three latent space vector variants or latent space vectors), are created according to sections “Choosing exploration directions in the latent space” and “Exploration/Exploitation”. Exploration directions are the directions in the latent space traversal and their magnitude is chosen according to the exploration/exploitation ratio, but is assured to be less than or equal to “epsilon” (e.g. a maximal controlled distance epsilon from said latent space vector).

### Iteration 1:

After producing said latent space vectors or latent space vectors variations {x_i2, x_i21, x_i22}, in step (3) the latent space vectors are used to generate media assets in the media space (e.g. new images, each image associated with a different vector variation) using the pre-trained generative model. Here the smoothness property of latent space is utilized to produce semantically/visually similar images namely the generated media assets changes are controlled semantically or visually compared to the media asset from step 1.

These 3 images (i.e. generated media asset) are then used in a A/B test, displayed to the users, providing feedback from (e.g. real users), as in step (4).

“A/B test 1” determines which generated media asset variations induced the best “KPI” value (step (5) e.g. measuring KPI performance associated with a KPI type). In this example it is variation x_i2 (non-dashed arrow) in this example x_i2 fails to meet an exit criterion and is selected as the basis for the next iteration.

As in step (6), the information from this experiment (e.g. “A/B test 1” KPI performance” results) is analyzed and used to influence the “exploration directions” for the next iteration.

Here it is demonstrated by way of example that as previously suggested, similar looking images induce similar “KPI”.

In some examples, the global population is not segmented, in which case step (7)) is obviated.

In step (8) the information gathered in step (6) is used (e.g. “A/B test 1” KPI performance” results) to influence the next iteration (for brevity it will not be repeated), in which control is reverted to step (2).

### Iteration 2:

As shown in the algorithm, after step (8) the algorithm repeats itself. Here the second iteration of the algorithm is shown:

In this iteration ‘x_i2’ associated with the selected media asset, is used to create three more latent vector variations {x_in, x_in1, x_in2} as in step (3) and generating corresponding three media assets which are subjected to the “A/B Test 2” as described in in step (4) to (6) above, thereby select the media asset (achieving the best KPI performance) that corresponds to latent vector x_in.

If the exit criterion was met as in (9), the selected media is outputted.

In the context of the present invention, the term “best/optimized/desirable” media asset may include the asset that achieves the highest measured performance according to the predefined Key Performance Indicator (KPI) type. For example, if the KPI is user engagement measured by click-through rate (CTR), the “best” asset is the one recording the highest CTR in the A/B test (e.g. following the iterative process as explained above). This definition ensures that “best” is rooted in quantifiable KPI metrics (e.g. values), rather than subjective criteria. In some embodiments, the highest KPI value must also exceed a predefined threshold (e.g., a minimum CTR for commercial viability), and/or other exit criterion (as explained above) thereby adding another layer of objective measurement to the selection process.

In some examples, the Key Performance Indicator (KPI) type used to evaluate and compare generated media assets may be selected from a diverse range of metrics. (a) User engagement metrics capture how users interact with the asset, for example by measuring click-through rates (CTR), total time spent viewing or interacting with the content, or conversion rates (e.g., the percentage of users who take a specified action). (b) Aesthetic or quality metrics assess both subjective and objective elements, such as user ratings of visual appeal or automated assessments that quantify visual realism or consistency with known design standards. (c) Relevance metrics evaluate the alignment of the asset's content with a predefined target audience, often using contextual cues such as demographic compatibility or topical fit. (d) Functional metrics focus on task completion or goal-driven success (e.g., how many users complete a registration process or finalize a purchase) to gauge the practical effectiveness of the asset. By tailoring the KPI to one or more of these categories, the system can systematically optimize media assets in accordance with the most meaningful objectives for a given application or deployment scenario.

### Non-Limiting Example 1: Sun Exposure Information Site

In this example, the process is used to find an optimal background image for a website that educates users about the dangers of prolonged sun exposure (i.e. media asset in media space). The Key Performance Indicator (KPI) in this scenario is the scrolling depth of the user. Initially, an authentic or AI-generated background image is encoded into a smooth or semi-smooth latent space of a pre-trained generative model. The system then chooses a direction (according to exploration exploitation as explained above) and generates one or more “controlled variation vectors,” each constrained by an upper threshold ∈\epsilon∈ on the allowed change in latent space distance, ensuring the generated images (each image is decoded from the control variation back to the media space) remain visually or semantically similar to the media asset (benefiting the smoothness of the latent space). These generated image variations are tested with real users via A/B testing. In some examples the A/B test further includes a ‘multi-armed bandit’ (as explained above). If one variant emerges as significantly better, according to the exit criterion the system either selects it as the “best media asset” or repeats the process by encoding it and using it for the next iteration. Over multiple iterations, the approach converges on an image that consistently leads to higher engagement, effectively driving users to read more information about sun safety.

In some examples, user segmentation is performed by analyzing user attributes such as geographic region, age bracket, device type, and prior interaction history. Suppose the system detects that users from ‘Region A’ exhibit a statistically significant preference for media variations with higher color contrast, while users from ‘Region B’ show stronger engagement with subtler color schemes. After verifying statistical significance (e.g., p-value <0.01), the user population is automatically partitioned into subpopulations. Each subgroup is then served a distinct set of controlled variations tailored to its discovered preferences. This segmentation logic continues iteratively, enabling fine-grained personalization and different search trajectories for each subgroup.

The foregoing examples are provided by way of illustration and are in no way intended to limit the scope of the disclosure or the appended claims. Persons of skill in the art will recognize that the invention can be readily adapted or extended to other media forms (e.g. text, video, audio), KPIs (e.g. click-through rates, user dwell time, conversion rates), and segmentation strategies (e.g. demographic, geographic, behavioral) without departing from the spirit of the disclosed subject matter.

There is provided a brief “summarized” Glossary and intuitive non-limitation construction of the terms. Note that the invention is by no means bound by these interpretations which are provided for clarity only,—

Authentic: Real, genuine, human-made media content.

AI-Generated: Content or results created by artificial intelligence (like text, images, or videos).

Controlled Media Variations: Variations for media assets which have been created by conditioning a generative model on “controlled latent variations”. Note that the terms change and variation may be used interchangeably.

Controlled Latent Variations: Variations for latent representations of media assets which have an upper threshold (epsilon) on the change magnitude. Note that the terms change and variation may be used interchangeably.

Search Trajectory: The path or steps taken during the media asset optimization process in the latent space. Each step consists of “controlled latent variations”.

Exploration Directions: The different directions in the latent space used to create the next batch of “controlled latent variations”.

Constraints: Limitations posed on the “controlled media variations”. Things that can not change from the original media. Or that have to be changed only in a certain way.

A/B Test: Split traffic test as per-se.

Latent Space: A lower dimensionality version of data where the key patterns or features are stored.

Step: A single step in the main algorithm

Encode: Retrieving the latent representation that can be used to generate a given media asset.

Epsilon: A threshold on a metric in latent space used to limit a “controlled variation” change magnitude.

In accordance with certain embodiments, the presently disclosed subject matter provides specific improvements to the functioning of computer systems that process and generate digital media assets. By operating directly within the structured latent-space representations of a pre-trained generative model—rather than relying on ad-hoc prompt manipulation, human-curated A/B testing, or manual feature engineering—the method enables the computer to traverse and manipulate media representations in a mathematically coherent, smooth or semi-smooth latent geometry. This architecture allows the system to perform controlled variation, efficient search, and iterative refinement in a manner that conventional media-optimization pipelines are not technically capable of achieving. The latent-space framework provides the computer with an improved internal data structure in which small coordinate changes correspond predictably to semantic or visual modifications, allowing automated generation of high-fidelity asset variants without sacrificing stability or specificity. The system further enhances computational performance by enabling automated selection of exploration directions, dynamic adjustment of variation magnitude, and segmentation-conditioned optimization loops, all executed as machine-implemented operations that restructure how the computer stores, transforms, and evaluates media representations. As a result, the disclosed method constitutes a technological improvement that enhances the computer's ability to encode, modify, and decode complex assets, increases efficiency in iterative testing cycles, reduces memory and processing overhead associated with trial-and-error prompt generation, and enables the computer to achieve outcomes that previously required human creative guidance, thereby improving the operation of the computer itself rather than merely using the computer as a tool.

It is to be noted that examples, equations, and numeral values illustrated in the present disclosure are illustrated merely for exemplary purposes and should not be regarded as limiting the present disclosure in any way. Other appropriate examples/implementations can be used in addition to, or in lieu of the above.

In the detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter. Unless specifically stated otherwise, as apparent from the discussions, it is appreciated that, throughout the specification, discussions, utilizing terms such as provide, encode, create, generate, conduct, selecting . . . or the like, refer to the action(s) and/or process(es) of a computer that manipulate and/or transform data into other data. The term “computer” should be expansively construed to cover any kind of hardware-based electronic device with data processing capabilities as described above.

The processor referred to in the current disclosure can represent one or more general-purpose processing devices, such as a microprocessor, a central processing unit, or the like. More particularly, the processor may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processor may also be one or more special-purpose processing devices, such as an application specific integrated circuit (ASIC), a field programmable gate array (FPGA), a digital signal processor (DSP), a network processor, or the like. The processor is configured to execute instructions for performing the operations and steps discussed herein.

The memory referred to herein can comprise a main memory (e.g., read-only memory (ROM), flash memory, dynamic random-access memory (DRAM) such as synchronous DRAM (SDRAM) or Rambus DRAM (RDRAM), etc.), and a static memory (e.g., flash memory, static random-access memory (SRAM), etc.).

The terms “non-transitory memory” and “non-transitory computer readable storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

Note that whenever the description refers to a method, it applies also to a system and non-transitory computer readable storage medium, mutatis mutandis, and vice versa.

The definitions set forth in this description are provided for convenience and explanatory purposes and are not intended to be limiting. Terms known in the art shall be interpreted to also include ordinary meaning in the relevant technical field, including recognized equivalents and variations thereof.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

Note that in accordance with certain embodiments, the order of computational stages described herein with reference to the drawings is not necessarily binding. For instance, the order of steps may be changed, steps may be modified or deleted, and/or other steps may be added instead of or in addition to those disclosed herein.

It is to be understood that the present disclosure is not limited in its application to the details set forth in the description contained herein or illustrated in the drawings.

It will also be understood that the system, according to the present disclosure, may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1) A computerized method for iterative media asset generation and optimization, comprising:
(i) providing a pre-trained generative model and a media asset in a media space;
(ii) encoding, by the generative model, the media asset into a latent space vector within a smooth or semi-smooth latent space such that controlled variations in the latent vector correspond to controlled semantic or visual variations in a corresponding media asset;
(iii) creating, in the latent space, at least two controlled latent variations of the latent vector, each variation being a latent space vector at a maximal controlled distance epsilon from the latent vector and generated along an exploration direction;
(iv) generating, using the generative model, at least two media assets corresponding to the controlled variations, the generated assets exhibiting controlled asset variations relative to the media asset or a previously selected media asset;
(v) conducting an A/B test by presenting the generated media assets to users and measuring KPI performance associated with a KPI type;
(vi) selecting the generated media asset having the best measured KPI performance; when the measured KPI of the selected media asset fails to satisfy an exit criterion,
(vii) repeating stages (ii)-(vi) using the selected media asset as the media asset for the next iteration; and
(viii) outputting the selected media asset when the exit criterion is satisfied.

2) The method of claim 1, wherein the exit criterion is selected from the group that includes:
a) the measured KPI associated with the selected media asset of the current iteration does not achieve improvement over the measured KPI associated with the selected media asset of a previous iteration;
b) the measured KPI meets or exceeds a given threshold.

3) The method according to claim 1, wherein said users are segmented to different user clusters and wherein said method further comprising:
identify at least one cluster of users, designated statistically distinct segment of users, that shows a statistically significant preference for one of the at least two generated media assets based on the measured KPI performances for the respective cluster of users,
apply the method steps (i) to (viii) independently for each identified cluster of users.

4) The method according to claim 1, wherein the generated media assets conform to asset constraints, the constraints including at least preserving specific at least one semantic element of the select media asset in the later generated at least two media assets.

5) The method according to claim 1, wherein selecting exploration directions in the latent space is done by using techniques selected from the group that includes: simulated annealing, evolutionary algorithms, or training a model to predict exploration directions.

6) The method according to claim 5, wherein selecting the exploration directions comprises applying an exploration/exploitation policy that determines whether the directions are selected to increase exploration by generating relatively more diverse or orthogonal directions in the latent space, or to increase exploitation by generating directions more closely aligned with a previously successful exploration direction.

7) The method according to claim 1, wherein the maximal controlled distance ‘epsilon’ is configured: manually, experimentally, or using a critic model.

8) The method according to claim 7, wherein configuring the maximal controlled distance epsilon comprises applying an exploration/exploitation policy that determines whether the controlled distance is set closer to the upper bound of epsilon to increase exploration or set to a smaller distance to increase exploitation.

9) The method of claim 1, wherein conducting the A/B test comprises dynamically allocating user traffic to the generated media assets using a multi-armed bandit algorithm that increases allocation to variants exhibiting higher KPI performance and decreases allocation to variants exhibiting lower KPI performance.

10) The method of claim 1, wherein creating the at least two controlled variations of the latent vector comprises selecting, for each variation, at least one of (i) a latent-space distance and (ii) an exploration direction, according to an exploration/exploitation policy, the policy determining whether the controlled variations are generated with relatively larger distances to increase exploration or relatively smaller distances to increase exploitation, and further determining relative orthogonality among the exploration directions.

11) A system for iterative media asset generation and optimization, comprising, by a Processor and Memory Circuitry (PMC) configured to:
provide a pre-trained generative model and a media asset in a media space;
encode, by the generative model, the media asset into a latent space vector within a smooth or semi-smooth latent space such that controlled variations in the latent vector correspond to controlled semantic or visual variations in a corresponding media asset;
create, in the latent space, at least two controlled latent variations of the latent vector, each variation being a latent space vector at a maximal controlled distance epsilon from the latent vector and generated along an exploration direction;
generate, using the generative model, at least two media assets corresponding to the controlled variations, the generated assets exhibiting controlled asset variations relative to the media asset or a previously selected media asset;
conduct an A/B test by presenting the generated media assets to users and measuring KPI performance associated with a KPI type;
select the generated media asset having the best measured KPI performance;
when the measured KPI of the selected media asset fails to satisfy an exit criterion, repeat the encode, create, generate, conduct and select operations with respect to the selected media asset as the media asset for the next iteration; and
output the selected media asset when the exit criterion is satisfied.

12) A non-transitory computer readable storage medium tangibly embodying a program of instructions that, when executed by a computer, cause the computer to perform a method of iterative media asset generation and optimization, comprising:
(i) providing a pre-trained generative model and a media asset in a media space;
(ii) encoding, by the generative model, the media asset into a latent space vector within a smooth or semi-smooth latent space such that controlled variations in the latent vector correspond to controlled semantic or visual variations in a corresponding media asset;
(iii) creating, in the latent space, at least two controlled latent variations of the latent vector, each variation being a latent space vector at a maximal controlled distance epsilon from the latent vector and generated along an exploration direction;
(iv) generating, using the generative model, at least two media assets corresponding to the controlled variations, the generated assets exhibiting controlled asset variations relative to the media asset or a previously selected media asset;
(v) conducting an A/B test by presenting the generated media assets to users and measuring KPI performance associated with a KPI type;
(vi) selecting the generated media asset having the best measured KPI performance; when the measured KPI of the selected media asset fails to satisfy an exit criterion,
(vii) repeating stages (ii)-(vi) using the selected media asset as the media asset for the next iteration; and
(viii) outputting the selected media asset when the exit criterion is satisfied.

13) The non-transitory computer readable storage medium of claim 12, wherein the exit criterion is selected from the group that includes:
a) the measured KPI associated with the selected media asset of the current iteration does not achieve improvement over the measured KPI associated with the selected media asset of a previous iteration;
b) the measured KPI meets or exceeds a given threshold.

14) The non-transitory computer readable storage medium according to claim 12, wherein said users are segmented to different user clusters and wherein said method further comprising:
identify at least one cluster of users, designated statistically distinct segment of users, that shows a statistically significant preference for one of the at least two generated media assets based on the measured KPI performances for the respective cluster of users,
apply the method steps (i) to (viii) independently for each identified cluster of users.

15) The non-transitory computer readable storage medium according to claim 12, wherein the generated media assets conform to asset constraints, the constraints including at least preserving specific at least one semantic element of the select media asset in the later generated at least two media assets.

16) The non-transitory computer readable storage medium according to claim 12, wherein selecting exploration directions in the latent space is done by using techniques selected from the group that includes: simulated annealing, evolutionary algorithms, or training a model to predict exploration directions.

17) The non-transitory computer readable storage medium according to claim 16, wherein selecting the exploration directions comprises applying an exploration/exploitation policy that determines whether the directions are selected to increase exploration by generating relatively more diverse or orthogonal directions in the latent space, or to increase exploitation by generating directions more closely aligned with a previously successful exploration direction.

18) The non-transitory computer readable storage medium according to claim 12, wherein the maximal controlled distance ‘epsilon’ is configured: manually, experimentally, or using a critic model.

19) The non-transitory computer readable storage medium according to claim 18, wherein configuring the maximal controlled distance epsilon comprises applying an exploration/exploitation policy that determines whether the controlled distance is set closer to the upper bound of epsilon to increase exploration or set to a smaller distance to increase exploitation.

20) The non-transitory computer readable storage medium of claim 12, wherein conducting the A/B test comprises dynamically allocating user traffic to the generated media assets using a multi-armed bandit algorithm that increases allocation to variants exhibiting higher KPI performance and decreases allocation to variants exhibiting lower KPI performance.
